(19) United States
(12) Patent Application Publication
(10) Pub. No.: US 2013/0007609 A1
(43) Pub. Date: Jan. 3, 2013

(54) CONSTRAINT BASED READING RECOMMENDATION

(75) Inventors: Nathan V. Bak, Portland, OR (US); Sukadev Bhattiprolu, Beaverton, OR (US); Elizabeth B. Silberg, Beaverton, OR (US)

(73) Assignee: INTERNATIONAL BUSINESS MACHINES CORPORATION, Armonk, NY (US)

(21) Appl. No.: 13/174,386

(22) Filed: Jun. 30, 2011

(51) Int. Cl. G06F 17/21

(52) U.S. Cl. 715/271; 715/273

(57) ABSTRACT

Systems, methods and computer program products may provide a constraint based reading recommendation on a computer. A method for generating a constraint based reading recommendation may include receiving an indication from a user indicating a desire to read a text item and determining a text item constraint including at least one of a time window constraint and an environmental constraint. The method may further include generating one or more approved text items in response to the text item constraint, the one or more approved text items including a recommended text item and displaying the recommended text item to the user.

### BACKGROUND

The present invention relates to generally to a constraint base reading recommendation. More specifically, the present invention relates to a constraint base reading recommendation including one of a time window constraint and an environmental constraint.

With the proliferation of “ebook” reading devices, people are able to easily carry with them many different choices of reading material. However, when a user has just a few minutes to read and/or varying levels of distraction, it can be difficult to make an appropriate selection. Currently, most devices and software implementation provide basic functionality to browse available reading choices and to easily continue reading on the last page read. While this is useful, it still can be difficult for users to determine which passage(s) they could read in an allotted time.

### BRIEF SUMMARY

According to one embodiment of the present invention, a method for generating a constraint based reading recommendation, via a data processing system, may include receiving an indication from a user indicating a desire to read a text item and determining a text item constraint including at least one of a time window constraint and an environmental constraint. The method may further include generating one or more approved text items in response to the text item constraint, the one or more approved text items including a recommended text item and displaying the recommended text item to the user.

In another embodiment of the present invention, a computer program product for providing a constraint based reading recommendation may include at least one computer readable storage medium having computer readable program code embodied therewith. The computer readable program code, when read by a processor, may be configured to receive an indication from a user indicating a desire to read a text item and determine a text item constraint including one of a time window constraint and an environmental constraint. The computer readable program code may also be configured to generate one or more approved text items in response to the text item constraint, the one or more approved text items including a recommended text item and display the recommended text item to the user.

In yet another embodiment of the present invention, a computer system may include a processor, a memory and a program for providing a constraint based reading recommendation. The program may include a plurality of instructions stored in the memory that are executed by the processor to receive an indicator from a user indicating a desire to read a text item and determine a text item constraint including one of a time window constraint and an environmental constraint. The plurality of instructions may further include instructions that are executed by the processor to generate one or more approved text items in response to the text item constraint, the one or more approved text items including a recommended text item and display the recommended text item to the user.

### BRIEF DESCRIPTION OF THE SEVERAL VIEWS OF THE DRAWINGS

FIG. 1 is a pictorial representation of an example of a computer system in which illustrative embodiments may be implemented.

FIG. 2 is a block diagram of an example of a computer in which illustrative embodiments may be implemented.

FIG. 3 is an example of a method for generating a constraint based reading recommendation.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF cable, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

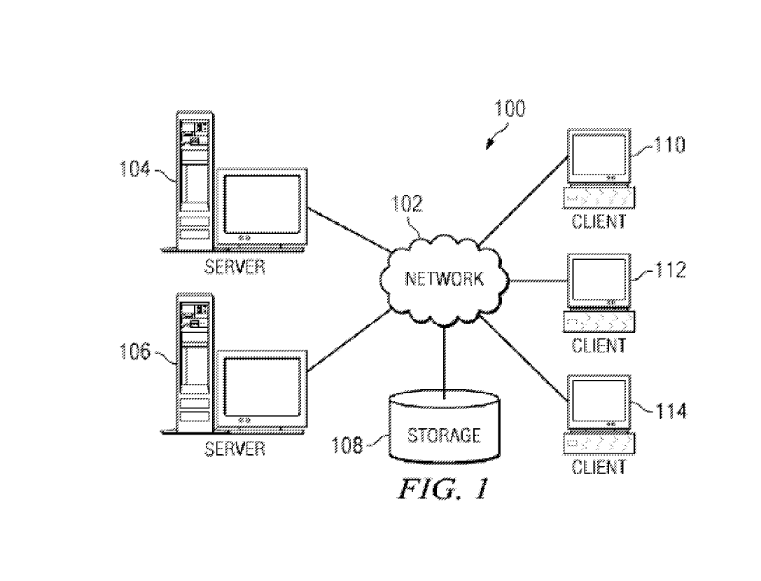

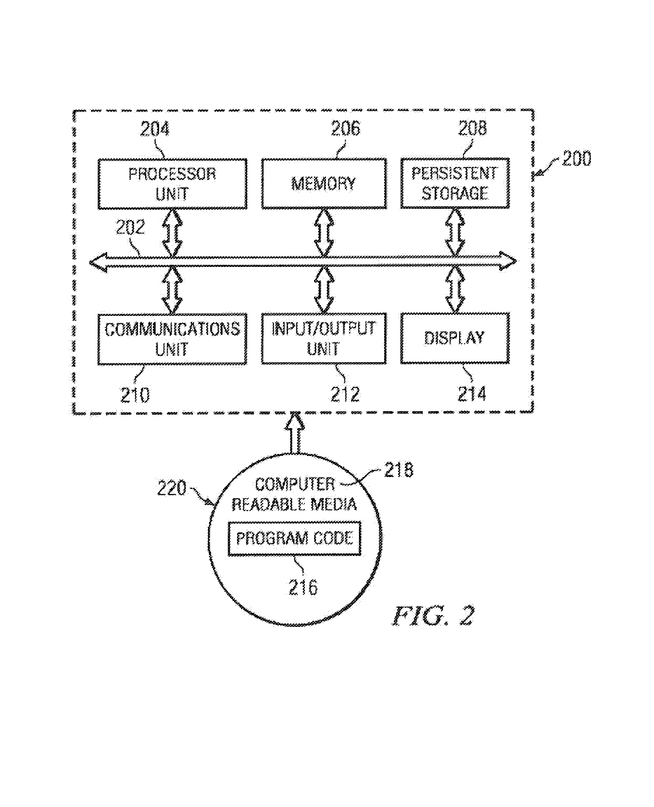

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a computer system, indicated generally at 100, and including a network of computers in which illustrative embodiments may be implemented. Computer system 100 may contain a network 102, which is the medium used to provide communications links between various devices and computers connected together within computer system 100. Network 102 may include connections, such as wire, wireless communication links, or fiber optic cables.

In the depicted example, a server 104 and a server 106 may connect to network 102 along with a storage unit 108. In addition, a first client computer 110, a second client computer 112, and a third client computer 114 may connect to network 102. Client computers 110, 112, and 114 may be, for example, personal computers or network computers. In the depicted example, server 104 may provide data, such as boot files, operating system images, and/or software applications to client computers 110, 112, and 114. Client computers 110, 112, and 114 are clients to server 104 in this example. Computer system 100 may include additional servers, clients, and other devices not shown, or may include fewer devices than those shown.

In the depicted example, network 102 may be or may include the Internet. Computer system 100 also may be implemented with a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client computer 110 in FIG. 1, in which computer-usable program code or instructions implementing the processes may be located for the illustrative embodiments. In this illustrative example, data processing system 200 includes communications fabric 202, which provides communications between a processor unit 204, a memory 206, a persistent storage 208, a communications unit 210, an input/output (I/O) unit 212, and display 214. In other examples, a data processing system may include more or fewer devices.

Processor unit 204 may serve to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. For example, communications unit 210 may be a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 displays information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 may be located in a functional form on a computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in tangible forms.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

In some embodiments of systems, methods and computer program products that provide a constraint based reading recommendation on a computer, parameters, also referred to as text item constraints, may be determined to generate one or more approved text items for a user. The one or more approved text items may include selection(s) that meet and/or fall within the text item constraint(s). Additionally and/or alternatively, the one or more approved text items may include selection(s) that best meet and/or fall within the text item constraint(s) of the available text items searched. The approved text items may include a recommended text item, which may be displayed to the user.

The approved text items may be generated from a selection of available text items, also referred to as a library. In some embodiments, the library may be stored remotely and/or accessed via the internet. Additionally and/or alternatively, the library may be stored in memory 206.

The user may be provided with the approved text items and may select the recommended text item. The user selection of the recommended text item may be accepted. Accordingly, the user may have a choice in selection of the recommended text item but may save time or make a more appropriate/desirable choice of reading material from the library in view of the text item constraint(s).

Additionally and/or alternatively, selection of the recommended text item from the one or more approved text items may be provided automatically. For example, one or more text items may include a pre-determined priority level. For example, the recommended text item may have a higher priority than the other approved text items. In some embodiments, the priority level of the recommended text item may be determined by a “due date” of a text item. The user could set a “due date” for different items in a reading queue. The due date could be used to prioritize between two or more approved text items. For example, if two approved text items are similar in reading time and difficulty, the one “due” first may have higher priority. Examples of a due date of a text item may include a work related deadline by which the text item must be read, a recreational deadline, such as a book club meeting and/or a library deadline.

The due date or priority of a text item may also be used to create a reading schedule for the user. For example, it may be determined that a text composition having a size may be divided into appropriately sized text items such that, by reading 15 minutes out of every day for the next two weeks, a user could finish reading the text composition by the due date of the text composition. This application may be useful for users that are reading novel X in order to have it done for a book club.

Additionally and/or alternatively, the due dates of more than one text composition may be created for a defined period of time. For example, if a user has a summer reading list including a number of text compositions, a different due date may be created for each such that the user may sequentially complete the text compositions in the summer reading list by the end of the summer.

In some embodiments, an estimated reading speed of the user may be determined. For example, the estimated reading speed of the user may be accepted from a user entry. Additionally and/or alternatively, the estimated reading speed may be determined by the age, grade level and/or other characteristics of the user. Additionally and/or alternatively, the actual reading speed of the user may be monitored, i.e. the time required to read a text item may be monitored. The estimated reading speed may be updated in response to the monitored reading speed. The updated estimated reading speed may be stored, for example in memory 206.

Additionally and/or alternatively, the estimated reading speed of the user could be vary depending on the category, subject matter, distraction level and/or difficulty level of the text item. For example, the user may have a first reading speed of humor text items, a second reading speed of kid text items, a third reading speed of financial/technical/legal text item, etc.

The text item constraint(s) may determine the size or length of the recommended text item and/or the content of the recommended text item. A text item may include material that is primarily text, primarily figures or diagrams (eg: diagrams in biology, construction drawings, maps, photographs) and/or a combination of text and figures/diagrams. The approximate level of difficulty of text items may be determined either from associated meta-data or calculated using well-known, established methods. The size or length of the different text items may also be determined using well-known, established methods. This information can be checked against previously obtained information (or default values) concerning how quickly the user can read different levels of content.

In some embodiments, the recommended text item may include an entire text composition, for example the recommended text item may include a short story, a blog entry, an article, etc. Alternatively, the recommended text item may include a portion of a textual composition. For example, the recommended text item may include a chapter of a novel or a passage of an article.

Additionally and/or alternatively, the recommended text item may access memory 206 to determine where the user left off reading a text composition and start at where the user last left off reading. One of the approved text items could include the “next chapter or page” in a novel the user has started reading. Where in the novel the user has stopped reading may be taken into account. In other words, reading materials may be partitioned, for example into chapters/articles. These partitions may need to be read sequentially (eg: spy novel) or can be read independently (eg: magazine article). The system could take input from the user (sequential or random) and use this to recommend the reading item.

In some embodiments, an exemplary text item constraint may include an available amount of time, also referred to as a time window constraint. The time window constraint may be determined using a current time and a stop time. Alternately, a start time of a time at some point in the future and a stop time may be used to determine the time window constraint. In some embodiments, a user-selection of time available for reading and/or stop time may be accepted. Alternatively, a stop time may be retrieved. In some embodiments, a stop time may be retrieved from a calendar stored in memory 206. The calendar may include scheduled appointments. For example, the invention could check the user's calendar and see an appointment is scheduled in 10 minutes and thus determine the user only has 10 minutes of reading time available.

Additionally and/or alternatively, a text item constraint may include a distraction level, also referred to as an environmental constraint. The environmental constraint may include considerations such as noise level, time of day, location, and/or number of surrounding people. For example, being in a quiet room or library would be lower distraction levels, while a busy waiting room or a subway would be higher distraction levels.

A user entry of the environmental constraint may be accepted. Additionally and/or alternatively, one or more sensors may be monitored to determine the environmental constraint. Exemplary sensors may include a sound sensor, a vibration sensor, a movement sensor, a light sensor, a microphone, an accelerometer, a GPS, and any other sensors known to those skilled in the art.

The following is a listing of additional and/or alternative text item constraints:
Amount of time (user input or calendar based)
Distraction level (noise and/or movement, could be microphone and/or accelerometer based)
Location/GPS based
Time of day (for example, the user prefers humorous content in the morning and non-fiction in the afternoon)
Reading speed (average, based on categories, etc)
Reading categories (kids/humor/serious reading)
Personalized reading habits/preference with categorized materials
User specified reasons for non-preferred reading material (too intense, too boring)
Rating system
Due date (discussed above)

In some embodiments, one or more text item constraints may be adjusted. For example, a first set of approved text items including a first recommended text item may be generated for a user in response to a first time window constraint. The user may spend two minutes skimming the first recommended text item and then perform an indication to indicate the first recommended text item is of no further interest. The first recommended text item may be removed from the set of approved text items. Additionally and/or alternatively, a second set of approved text items including a second recommended text item may be generated in response to a second time window constraint. The second time window constraint may be two minutes shorter than the first time window constraint.

Other user generated indications may also adjust and/or add one or more text item constraints. For example, the user may not being “in the mood” for a particular text item at the moment, in which case a text item constraint may be added to exclude reading selections in the same category.

The following is an exemplary embodiment of the present invention:

1. The user performs an indication to indicate a desire to read some non-specific content

2. The invention determines what constraints currently exist

3. The invention searches a library for content meeting defined constraints

4. The invention either takes the user directly to the “best” match or to an ordered list of matches

5. If the user indicates a desire to read something else, the invention automatically adjusts the constraints to provide new reading selections

6. As the user reads, the invention stores information (i.e., “learns”) about the how long it takes to read different lengths of text at different difficulty levels and continues to optimize selection process.

In another embodiment of the invention, one or more text item constraints may be used to identify appropriate selections from a library. The invention enables a user that reads via an ereader device to choose which reading passage to read at a particular point in time, based on constraints and preferences known about the user (or entered manually by the user), such as the length of time available for reading, the energy level of the reader, the interest (i.e., work related document, casual fiction document, document for a particular hobby, etc.) Other factors used by the invention may include: distractions in the environment and information about the reader's history (reading likes, progress in longer selections and rates of reading).

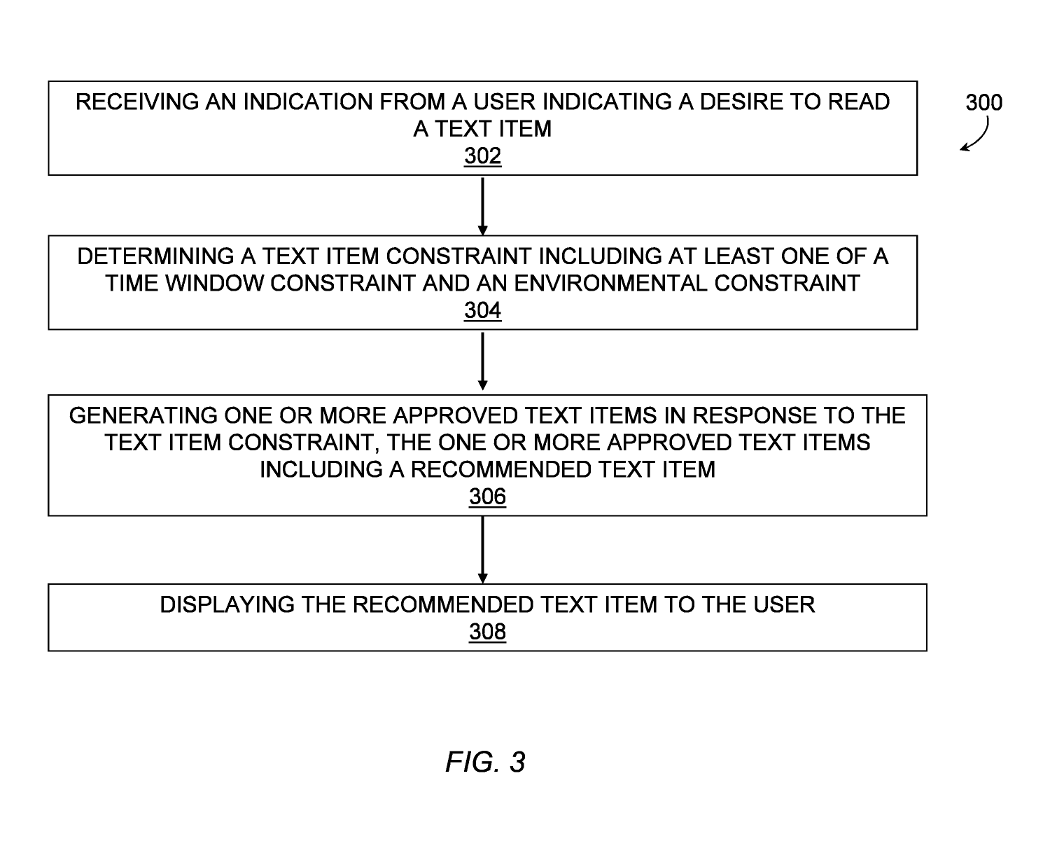

Referring now to FIG. 3, an example of a method for generating a constraint based reading recommendation is shown. While FIG. 3 shows exemplary steps of a method according to one embodiment, other embodiments may omit, add to, and/or modify any of the steps shown in that figure. In step 302, an indication may be received from a user indicating a desire to read a text item. In step 304, a text item constraint may be determined. The text item constraint may include at least one of a time window constraint and an environmental constraint. In step 306, one or more approved text items may be generated in response to the text item constraint. The one or more approved text items may include a recommended text item. In step 308, the recommended text item may be presented or displayed to the user. In some embodiments of method 300, the text item constraint may determine the size of the recommended text item and the content of the recommended text item. Additionally and/or alternatively, in some embodiments the recommended text item includes a portion of a textual composition.

Method 300 may include other steps. For example, method 300 may include displaying for selection by the user the one or more approved text items and accepting a user selection of the recommended text item. Furthermore, method 300 may include selecting the recommended text item from the one or more approved text items, wherein selection of the recommended text item is at least partially based on a pre-determined priority level of the recommended text item.

Method 300 may further include determining an estimated reading speed of the user. Additionally, method 300 may include monitoring the reading speed of the user, updating the estimated reading speed of the user and storing the updated estimated reading speed of the user in a memory of the data processing system.

Method 300 may additionally include monitoring an environmental sensor. Method 300 may further include receiving from the user an indication indicating a desire to reject the recommended text item and adjusting the text item constraint in response to the user's indication. Furthermore, method 300 may include generating one or more approved text items in response to the adjusted text item constraint

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for generating a constraint based reading recommendation, via a data processing system, the method comprising:
receiving an indication from a user indicating a desire to read a text item;
determining a text item constraint including at least one of a time window constraint and an environmental constraint;
generating one or more approved text items in response to the text item constraint, the one or more approved text items including a recommended text item; and
displaying the recommended text item to the user.

2. The method of claim 1, further comprising:
displaying for selection by the user the one or more approved text items; and
accepting a user selection of the recommended text item.

3. The method of claim 1, further comprising:
selecting the recommended text item from the one or more approved text items, wherein selection of the recommended text item is at least partially based on a pre-determined priority level of the recommended text item.

4. The method of claim 1, further comprising:
determining an estimated reading speed of the user.

5. The method of claim 4, further comprising:
monitoring the reading speed of the user;
updating the estimated reading speed of the user; and
storing the updated estimated reading speed of the user in a memory of the data processing system.

6. The method of claim 1, further comprising one of:
accepting a stop time of the time window constraint from the user; and
retrieving a stop time of the time window constraint from a memory of the data processing system.

7. The method of claim 1, further comprising:
monitoring an environmental sensor.

8. The method of claim 1, wherein the text item constraint determines the size of the recommended text item and the content of the recommended text item.

9. The method of claim 1, further comprising:
receiving from the user an indication indicating a desire to reject the recommended text item; and
adjusting the text item constraint in response to the user's indication.

10. The method of claim 1, wherein the recommended text item includes a portion of a textual composition.

11. A computer program product for providing a constraint based reading recommendation, the computer program product comprising:
at least one computer readable storage medium having computer readable program code embodied therewith, the computer readable program code, when read by a processor, configured to:
receive an indication from a user indicating a desire to read a text item;
determine a text item constraint including one of a time window constraint and an environmental constraint;
generate one or more approved text items in response to the text item constraint, the one or more approved text items including a recommended text item; and
display the recommended text item to the user.

12. The computer program product of claim 11, wherein the computer readable program code, when read by a processor, is further configured to:
determine an estimated reading speed of the user.

13. The computer program product of claim 11, wherein the computer readable program code, when read by a processor, is further configured to:
monitor an environmental sensor.

14. The computer program product of claim 11, wherein the computer readable program code, when read by a processor, is further configured to:
receive from the user an indication indicating a desire to reject the recommended text item; and
adjust the text item constraint in response to the user's indication.

15. The computer program product of claim 14, wherein the computer readable program code, when read by a processor, is further configured to:
generate one or more approved text items in response to the adjusted text item constraint.

16. A computer system, comprising:
a processor;
a memory; and
a program for providing a constraint based reading recommendation, the program including a plurality of instructions stored in the memory that are executed by the processor to:
receive an indication from a user indicating a desire to read a text item;
determine a text item constraint including one of a time window constraint and an environmental constraint;
generate one or more approved text items in response to the text item constraint, the one or more approved text items including a recommended text item; and
display the recommended text item to the user.

17. The computer system of claim 16, wherein the plurality of instructions further includes instructions that are executed by the processor to:
monitor the reading speed of the user; and
determine an estimated reading speed of the user.

18. The computer system of claim 16, wherein the plurality of instructions further includes instructions that are executed by the processor to:
receive from the user an indication indicating a desire to reject the recommended text item; and
adjust the text item constraint in response to the user's indication.

19. The computer system of claim 18, wherein the plurality of instructions further includes instructions that are executed by the processor to:
generate one or more approved text items in response to the adjusted text item constraint.

20. The computer system of claim 16, wherein the plurality of instructions further includes instructions that are executed by the processor to:
monitor an environmental sensor.
